(19) United States
(12) Patent Application Publication
(10) Pub. No.: US 2005/0228625 A1
(43) Pub. Date: Oct. 13, 2005

(54) Method and system for modeling ocean waves

(76) Inventor: Lawrence M. Lachman, Dallas, TX (US)

Correspondence Address: FISH & RICHARDSON P.C., 1717 MAIN STREET, SUITE 5000, DALLAS, TX, 75201, US

(21) Appl. No.: 11/086,522

(22) Filed: Mar. 22, 2005

Related U.S. Application Data
(60) Provisional application No. 60/561,426, filed on Apr. 12, 2004.

(51) Int. Cl. G06G 7/48

(52) U.S. Cl. 703/9

(57) ABSTRACT

A method and system for modeling wave conditions is provided. In one embodiment, software is operable to identify foreign wave simulation algorithms, with the algorithms operable to determine wave conditions. The software dynamically generates a simulation of the wave conditions based, at least in part, on the foreign wave simulation algorithms.

### RELATED APPLICATION

This application claims the benefit of U.S. Provisional Application No. 60/561,426 filed Apr. 12, 2004.

### TECHNICAL FIELD

This invention relates to modeling and, more particularly, to a method and system for modeling ocean waves.

### BACKGROUND

Modeling complex real objects typically requires developing complex software programs. The software programs include reusable classes, functions, routines, or subroutines that determine various attributes of a modeled object. For example, these tools may determine the geometry (e.g., shape, dimensions, and location) in combination with other attributes (e.g., color and texture) of the modeled object. Such tools may be used to generate simulations of water such as ocean water simulations. Conventionally, wave generations are typically generated from predefined geometries and textures.

### SUMMARY

A method and system for modeling wave conditions is provided. In one embodiment, a method includes identifying foreign wave simulation algorithms, with the algorithms operable to determine wave conditions. A simulation of wave conditions is dynamically generated based, at least in part, on the foreign wave simulation algorithms. The details of one or more embodiments of the invention are set forth in the accompanying drawings and the description below.

### DESCRIPTION OF DRAWINGS

FIG. 1 is a block diagram illustrating an open modeling system in accordance with one embodiment of the present disclosure;

FIGS. 2A-D illustrate a grid structure in accordance with open modeling system of FIG. 1; and

FIG. 3 is a flow diagram illustrating an example method for simulating wave conditions.

### DETAILED DESCRIPTION

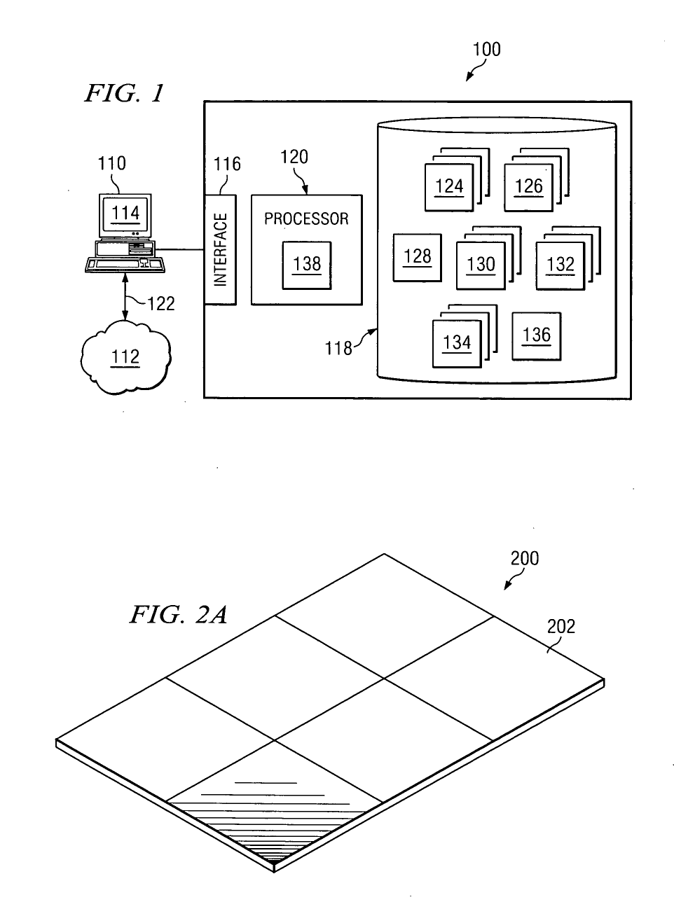

FIG. 1 is a block diagram illustrating an open modeling system 100 for providing visual simulation of wave conditions using foreign wave-simulation algorithms. Foreign, as used herein, means any component, algorithm, or variable that is provided by a process, device, or individual external to computer 110 or the particular process, such as a rendering engine 138. Wave conditions include a physical state of a liquid such as, for example, an ocean, a river, a lake, or any other suitable body of liquid. For example, a user may provide these foreign wave-simulation algorithms to system 100 for generating a visual simulation of ocean water. In another example, one separate algorithm is provided to modeling system 100 within computer 110. Such foreign wave-simulation algorithms may be added to system 100 by deriving from a wave generator template 124, which is, in one embodiment, an abstract base class that provides the interface for user-derived classes to provide the implementation content. Wave condition simulations (e.g., ocean water simulations) are typically a computationally expensive process and a difficult problem for applications that require visually plausible three-dimensional effects at high frame rates. In one embodiment, system 100 introduces new algorithms for rendering wave conditions (e.g., ocean waves) in a unified manner, while foreign simulation algorithms perform the generation and animation of the waves, modify the character of the liquid surface (e.g., ocean surface), and manage the underlying physics. Once wave conditions are determined, rendering engine 138, in one embodiment, manages paging of geometry, minimizing memory requirements, determining the level of detail for wave condition cells and their underlying geometry, culling wave condition cells to view frustum, and triangle stripping.

At a high level, system 100 may be a single computer 110 or any portion of a distributed or enterprise system including at least computer 110, perhaps communicably coupled to a network 112. For example, computer 110 may comprise a portion of an information management system that provides a number of software applications to any number of clients. Alternatively, computer 110 may comprise a client processing information in a distributed information management system or enterprise network via one or more software applications. In either case, system 100 is any system operable to dynamically generate a visual simulation of wave conditions based, at least in part, on foreign wave-simulation algorithms. The term “dynamically” as used herein, generally means that the appropriate processing is determined at run-time based upon the appropriate information. This configuration often provides a substantially realistic, flexible, and inexpensive mechanism for visually simulating wave conditions in accordance with a visually simulated vessel whose orientation and position is affected by the same wave conditions.

Computer 110 includes a Graphical User Interface (GUI) 114, network interface 116, memory 118, and processor 120. FIG. 1 only provides one example of a computer that may be used with the disclosure. The present disclosure contemplates computers other than general purpose computers as well as computers without conventional operation systems. As used in this document, the term “computer” is intended to encompass a mainframe, a personal computer, a client, a server, a workstation, a network computer, a personal digital assistant, a mobile phone, or any other suitable processing device. Computer 110 may be operable to receive input from and display output through GUI 114 for the particular user.

GUI 114 comprises a graphical user interface operable to allow the user of computer 110 to interact with processor 120. The term “computer 110” and the phrase “user of computer 110” may be used interchangeably, where appropriate, without departing from the scope of this disclosure. Generally, GUI 114 provides the user of computer 110 with an efficient and user-friendly presentation of data provided by computer 110. GUI 114 may comprise a plurality of displays having interactive fields, pull-down lists, and buttons operated by the user. And in one example, GUI 114 presents an explorer-type interface and receives commands from the user. It should be understood that the term graphical user interface may be used in the singular or in the plural to describe one or more graphical user interfaces in each of the displays of a particular graphical user interface. Further, GUI 114 contemplates any graphical user interface, such as a generic web browser, that processes information in computer 110 and efficiently presents the information to the user. Network 112 can accept data from the user of computer 110 via the web browser (e.g., Microsoft Internet Explorer or Netscape Navigator) and return the appropriate HTML or extensible Markup Language (XML) responses.

As appropriate, computer 110 generates requests and/or responses and communicates them to another client, server, or other computer systems located in or beyond network 112. For example, computer 110 may receive data for a visual simulation. Network 112 facilitates wireless or wireline communication between computer system 100 and any other computer. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Computer 110 may include network interface 116 for communicating with other computer systems over network 112 such as, for example, in a client-server or other distributed environment via link 122. Generally, interface 116 comprises logic encoded in software and/or hardware in any suitable combination to allow computer 110 to communicate with network 112 via link 122. More specifically, interface 116 may comprise software supporting one or more communications protocols associated with link 122 and communications hardware operable to communicate physical signals.

Memory 118 may include any memory or database module and may take the form of volatile or non-volatile memory including magnetic media, optical media, Random Access Memory (RAM), Read Only Memory (ROM), removable media, or any other suitable local or remote memory component. In the illustrated embodiment, memory 118 includes wave generator template 124, derived templates 126, wave generator object 128, data structures 130, functor templates 132, functors 134, and wave model 136. In general, wave generator template 124 defines an interface for implementing foreign wave-simulation algorithms, and derived template 126 may be derived from wave generator template 124 by adding content associated with these foreign wave-simulation algorithms. In the case that the foreign wave-simulation algorithms include a foreign energy spectrum and a foreign spreading function, functor templates 132 associated with the foreign energy spectrum and the foreign spreading function may be selected. Based, at least in part, on the selected functor templates 132, computer 110 may instantiate functors 134. Regardless of whether system 100 implements functors 134 and/or wave model 136, computer 110 instantiates wave generator object 128 based, at least in part, on derived template 126, and wave generator object 128 is operable to invoke functors 134 and/or wave model 136 while determining wave conditions. Wave generator template 124 comprises a file, script, executable, template or any other suitable description that at least partially defines an interface, thereby enabling system 100 to implement foreign wave-simulation algorithms. In general, wave generator template 124 provides one or more of the following: an ability to update wave conditions, an ability to query foreign wave-simulation algorithms for height, position and other suitable parameters, and an ability to populate a predefined data grid with multi-component data.

In one embodiment, wave generator template 124 defines an interface enabling system 100 to invoke a foreign energy spectrum and a foreign spreading function. In this example, the foreign energy spectrum and the foreign spreading function may be invoked using a functor associated with each—If the associated functor is based on a stand-alone function, wave generator template 124 may invoke the functor as follows:
int nReturnCode=someFuncFunctor(3.14,3.14f);
If the functor is based on a member function of a class object, wave generator template 124 may invoke the functors as followed:
int nReturnCode=methodFunctor(“hello world”);
   These example invocations are for illustration purposes only and wave generator template 124 may comprise any logic (represented by none, some, or all of the illustrated invocations as well as that not illustrated) operable to invoke functors associated with a foreign energy spectrum and a foreign spreading function. In another embodiment, wave generator template 124 may (alternatively or in combination with derived template 126) define an interface enabling system 100 to use a foreign wave model. As a result, a user of system 100 may completely define the wave model implemented and may directly sum the frequencies associated with their unique spectra. In the foreign-wave-model example, wave generator template 124 or derived template 126 may include one or more of the following properties:
setNumberOfSpectra( ) may set the number of spectra that comprise a single short-crested spectrum. The spectra may not be completely independent because one modal period and one predominant wave heading may characterize components of a short crested wave spectrum.
setNumberOfWaveComponents( ) may set the number of wave components that comprise this spectrum.
setWaveComponents( ) may set the wave components of the specified spectrum (e.g., angular frequencies, phase angles, and wave heading).
setNumberOfSpectra( ) and setNumberOfWaveComponents( ) may be called prior to invoking this function. All components may correspond to the same wave heading.
configure( ) may configure a wave generator object. All spectra and their components may be set prior to invoking this function. Part of the initialization process may involve invoking preComputeWaves( ), which may set the amplitudes for each of the spectra and compute the angular frequencies.
setMeshResolution( ) may set the resolution (the number of subdivisions of the highest level of detail) of visually simulated wave conditions. The resolution in X and Y may be any number.
update( ) may compute a time-dependent portion of a wave elevation for a specified elapsed simulation time and then update the wave conditions.
getHeight( ) may return a height of a wave at a specified horizontal position, which may be in any appropriate coordinates (e.g., Cartesian, Geodetic).
getvelocity( ) may return a vertical velocity or the velocity vector of a wave at a specified horizontal position. Vertical velocity may be determined as the time derivative of height.
getNormal( ) may return a surface normal of a wave at a specified horizontal position. A surface normal is typically an imaginary line that is perpendicular to the surface of a polygon. It may also be computed at the vertex of a triangle.
   It will be understood that the properties list above are for illustration purposes only, and wave generator template 124 may comprise any logic (represented by none, some, or all of the illustrated properties as well as that not illustrated) operable to implement a foreign wave model. Wave generator template 124 may include or be based on source code written in any appropriate language such as, for example, C, C++, Java, Perl, Visual Basic, and others. Wave generator template 124 may be created, modified, or supplied by computer 110, a third-party software vendor, or any appropriate user of any computer in system 100, loaded from a default profile, or received via network 112.

In one embodiment, a user of system 100 may generate a derived template 126 based on wave generator template 124 in order to interface foreign wave-simulation algorithms with system 100. For example, wave generator template 124 may comprise an abstract base class such that derived template 126 comprises a derived class and inherits member variables and methods of wave generator template 124, thereby enabling foreign wave-simulation algorithms to interface system 100. In the abstract class example, wave generator template 124 includes virtual methods and pure virtual methods. In this example, one or more of the derived templates 126 may be created by providing content for the virtual methods and pure virtual methods, as well as providing methods specific to the foreign wave simulation algorithm that the derived template implements. In the illustrated embodiment, wave generator template 124 may include the following two pure virtual functions: configure( ) and update( ). Once content is provided for these pure virtual functions, configure( ) is operable to initialize the wave conditions and generate amplitudes and phases at time zero and update( ) is operable to update wave conditions including, for example, height, normal, and other parameters.

Based, at least in part, on wave generator template 124, derived template 126 may comprise a file, script, executable, template or any other suitable description such that computer 110 may instantiate a wave generator object 128 implementing specified foreign wave-simulation algorithms. A user of and/or process in system 100 may develop or populate derived template 126 from wave generator template 124 by inserting information or otherwise modifying wave generator template 124 with information that identifies foreign wave-simulation algorithms. As discussed above, in the case of a foreign energy spectrum and a foreign spreading function, a user and/or process may insert information identifying functors associated the foreign energy spectrum and the foreign spreading function. In the case of a foreign wave model, a user and/or process may insert information identifying a foreign wave model. In either case, additional information may be inserted such that derived template 126 is operable to invoke foreign wave-simulation algorithms when generating wave conditions. Derived template 126 may be any suitable format such as, for example, an XML document, a flat file, CSV file, a name-value pair file, SQL table, source code, object code, or others. Moreover, derived template 126 may be created, modified, or supplied by computer 110, a third-party software vendor, or any appropriate user of any computer in system 100, loaded from a default profile, or received via network 112.

Based, at least in part, upon derived template 126, computer 110 instantiates at least one wave generator object 128. Wave generator object 128 comprises any software component operable to generate data that describes wave conditions at a given point in time. As used herein, software generally includes any appropriate combination of software, firmware, hardware, and/or other logic. In certain embodiments, wave generator object 128 may be an instantiated object based on a class defined in an appropriate object-oriented programming language. For example, wave generator object 128 may be based, at least in part, on classes written in C++, Java, or any other suitable language. Wave generator object 128 may generate wave condition data by determining surface heights or amplitudes of a liquid at specific positions at a point in time. This determination may be based on one or more of the following parameters: wave spectrum, wind speed, wind direction, modal period, phase angle, amplitude of a wave with a specific frequency, energy of a wave with a specific frequency, frequency distribution, wave conditions, and others. In addition, wave generator object 128 may transform between time (or spatial) domain and the frequency domain using Fourier Transforms (e.g., Fast Fourier Transforms). In this case, wave generator object 128 performs calculations in the frequency domain to reduce or minimize the complexity of the required calculations (of generating wave-condition data). In one embodiment, wave generator object 128 calls or otherwise invokes foreign wave-simulation algorithms in the process of generating wave-condition data. In this embodiment, wave generator object 128 may pass parameters to foreign wave-simulation algorithms and process received results. The results may include amplitudes of waves at specific frequencies, energies of waves at specified frequencies, surface heights of the liquid, and others. Once wave generator object 128 generates or otherwise determines wave-condition data, wave generator object 128 may store the wave-condition data into a predetermined multi-component format in one or more data structures 130.

Data structure 130 comprises one or more entries or data structures that describe wave conditions. For example, data structure 130 may describe the amplitude or height of a liquid surface at a position and time. Generally, data structure 130 includes a predetermined structure of multi-component data. In one embodiment, the structure is an array including multiple rows and columns. In this embodiment, each row is associated with a corresponding set of positions on a liquid surface and each column is associated with a different set of positions on the surface. Each position is characterized and associated with various properties. For example, these characteristics may include one or more of the following: angular frequency, position, time, height, normal, wind speed, wind direction, modal period, phase angle, wave number, distance between successive wave crests, heading of a wave train, amplitude of a wave with a specific frequency, energy of a wave with a specific frequency, frequency distribution, wave conditions, and others. Data structure 130 may be any suitable format such as, for example, an XML document, a flat file, a CSV file, a name-value pair file, SQL table, an array, an object, or others. Data structure 130 may be dynamically created or populated by computer 110, a third-party vendor, any user of computer 110, loaded from a default file, or received via network 112. In some embodiments, each data structure 130 is a unified data structured. In this embodiment, computer 110 generates data structures 130 in the same format regardless of the underlying wave model that computer 110 implements (i.e., regardless of how derived template 126 implements a specific wave model.) The unified data may consist of the multi-component data. For example, the multi-component data elements may be height (ID), horizontal position (2D), and normal (3D). This embodiment may allow computer 110 to operate with a single rendering engine 138 (discussed below) because a single format is used.

Each functor template 132 may comprise a file, script, executable, template or any other suitable description such that processor 120 may instantiate a functor 134 operable to implement one or more foreign wave-simulation algorithms. In general, functor template 132 may allow a user to plug in foreign wave-simulation algorithms instead of relying on native wave-simulation algorithms. In this case, derived template 126 could employ functor template 132 to allow users to plug in specified functions. A first functor template 132 may be associated with a foreign energy spectrum and a second functor template 132 may be associated with a foreign spreading function. In this example, processor 120 may instantiate first and second functor 134 based, at least in part, on the first and second functor templates 132, respectively. Alternatively or in combination, each functor template 132 may be associated with a plurality of foreign wave-simulation algorithms. In addition, functor templates 132 may be associated with a stand-alone function, a static method of a class, a member function of a class object, or any other suitable element. In the case that functor template 132 is associated with a stand-alone function or a static method of a class, functor template 132 may comprise the following structure:

int someFunc( double, float) {}
. . .
vuFunctorR2<int, double, float>
someFuncFunctor( someFunc, 0)

In the case that functor template 132 is associated with a member
function of a class
object, functor template 132 may comprise the following structure:

class MyClass {
public:

int someMethod( const char* );

};
. . .
vuFunctorR1<int, MyClass *> methodFunctor(

pMyClassObject, MyClass::someMethod, 0);

These example structures are for illustration purposes only and functor template 132 may comprise any logic (represented by none, some, or all of the illustrated invocations as well as that not illustrated) such that computer 110 may instantiate associated functors 134. Functor templates 132 may be associated with a specified number of arguments and may or may not return a value. In one embodiment, the following naming conventions may be implemented:
vuFunctorN< > identifies that an associated functor 134 processes N arguments and does not return values; and
vuFunctorRN< > identifies that an associated functor 134 processes N arguments and does return values.
   These example naming conventions are for illustration purposes only and functor templates 132 may comprise any name convention (represented by none, some, or all of the illustrated invocations as well as that not illustrated) operable to identify a number of arguments and whether an associated functor 134 returns a value. In one embodiment, functor template 132 includes or is based on source code written in any appropriate language such as, for example, C, C++, Java, Perl, Visual Basic, and others. Functor template 132 may be dynamically created by computer 110, a third-party vendor, any suitable user of computer 110, loaded from a default file, or received via network 112. Functor template 132 may also be in any electronic format such as, for example, an XML document or any other suitable format.

Using functor template 132, computer 110 instantiates at least one functor 134. As mentioned above, functor 134 comprises any software component operable to determine one or more characteristics of wave conditions in accordance with associated foreign wave-simulation algorithms. In one embodiment, functor 134 receives parameters associated with a foreign wave-simulation algorithm and based, at least in part, on the received parameters determines one or more characteristics of wave conditions. For example, functor 134 may determine an amplitude of a liquid surface at each point of a grid, which may be determined during the update of wave conditions. In one embodiment, functor 134 includes or otherwise identifies a foreign energy spectrum and/or a foreign spreading function and determines one or more characteristics based, at least in part, on the foreign energy spectrum and/or foreign spreading function. The foreign energy spectrum may comprise a wave spectral density function used to predict wave amplitudes based upon certain wave components. The foreign energy spectrum may comprise or otherwise identify a formula for determining energy of a wave with a specified frequency that is traveling at a specified angle relative to a dominant wave direction and may include a frequency distribution and an angular spreading of wave energy. Functor 134 may also facilitate decoupled interobject communication and may include one or more of the following features or functions: (1) accepts pointers to simple functions, pointers to member functions, and/or other functors 134 together with some or all of their respective arguments; (2) is typesafe by preventing the matching of wrong argument types to wring argument functions; and (3) is an object with value semantics by fully supporting copying, assignment, and pass by value. In one embodiment, functor 134 can store state and invoke member functions.

Wave model 136 is typically software operable to determine wave conditions based, at least in part, on received parameters and may be written or described in any appropriate computer language including, for example, C, C++, Java, J#, Visual Basic, assembler, Perl, any suitable version of 4GL, or any combination thereof. For example, wave model 136 may simulate one or more of the following aspects of wind waves: generation, propagation, shoaling, interaction, refraction, and reflection. In one embodiment, a user of system 100 completely defines wave model 136 and wave model 136 may directly sum the frequencies associated with its specified spectra. With regard to the received parameters, wave model 136 may receive one or more of the following: a number of spectra that comprise a single short-crested spectrum, a number of wave components that comprise a spectrum, angular frequencies, phase angles, and/or wave headings of a specified spectrum, and initial amplitudes for each spectra. Based on one or more of these and/or other received parameters, wave model 136 may determine and return one or more of the following: resolution of a wave-condition mesh, time-dependent portion of a wave elevation for a specified elapsed time, height of a wave at a specified horizontal position (e.g., Cartesian coordinates, Geodetic coordinates), a vertical velocity of a wave at a specified horizontal position (time derivative of height), and a horizontal gradient of a height at a specified horizontal position (e.g., spatial derivative of height). Wave model 136 may be based on any appropriate computer language and, while wave model 136 is illustrated as a single multitasked module, the features and functionality performed by this engine may be performed by multiple modules. Moreover, wave model 136 may comprise a child or submodule of another software module, not illustrated, without departing from the scope of this disclosure.

Processor 120 executes instructions and manipulates data to perform operations of computer 110. Although FIG. 1 illustrates a single processor 120 in computer 110, multiple processors 120 may be used according to particular needs, and reference to processor 120 is meant to include multiple processors 120 where applicable. In the illustrated embodiment, processor 120 executes rendering engine 138 at any appropriate time such as, for example, in response to a request or input from a user of computer 110 or any appropriate computer system coupled with network 112. Rendering engine 138 is generally operable to provide one or more of the following features or functions: managing paging of geometry, minimizing or reducing memory requirements, determining level of detail for wave-condition cells and their underlying geometry, culling wave-condition cells to view frustrum, and triangle stripping.

Rendering engine 138 includes any suitable hardware, software, firmware, or combination thereof operable to identify wave-condition data determined by wave generator object 128 and generate a visual simulation of the wave-condition data. For example, rendering engine 138 may retrieve amplitudes of a liquid surface and generate a visual simulation of wave conditions, based at least in part, on the retrieved amplitudes. Rendering engine 138 may be based on any appropriate computer language and, while rendering engine 138 is illustrated as a single multitasked module, the features and functionality performed by this engine may be performed by multiple modules. Moreover, rendering engine 138 may comprise a child or submodule of another software module, not illustrated, without departing from the scope of this disclosure.

In one aspect of operation, a user selects a wave generator template 124 associated with foreign wave simulations algorithms. For example, a user may select a wave generator template 124 associated with a foreign energy spectrum and a foreign spreading function. A derived template 126 is then derived from the selected wave generator template 124 by including invocations to associated functors 134 and/or model 136. Returning to the example, derived template 126 is derived from wave generator template 124 by including content identifying functors 134, which are operable to implement the foreign energy spectrum and the foreign spreading function. After generating derived template 126, computer 110 instantiates wave generator object 128 based, at least in part, on derived template 126. In the case that the identified foreign wave-simulation algorithms include a foreign energy spectrum and a foreign spreading function, a user of system 100 selects functor templates 132 associated with foreign energy spectrums and a foreign spreading functions. Based, at least in part, on selected functor templates 132, computer 110 instantiates one or more functors 134, and functor 134 is operable to implement the foreign wave simulation algorithms. Regardless, after wave generator object 128 is instantiated, wave generator object 128 invokes functors 132 and/or model 136 to generate wave condition data and store the data in data structure 130. In the example, wave generator object 128 pass parameters to functor 134, and functor 134 generates wave conditions (e.g., amplitudes of a liquid surface) based, at least in part, on the received parameters. Rendering engine 138 may then retrieve stored data and generate a visual simulation of wave conditions at a given point in time based, at least in part, on the retrieved data.

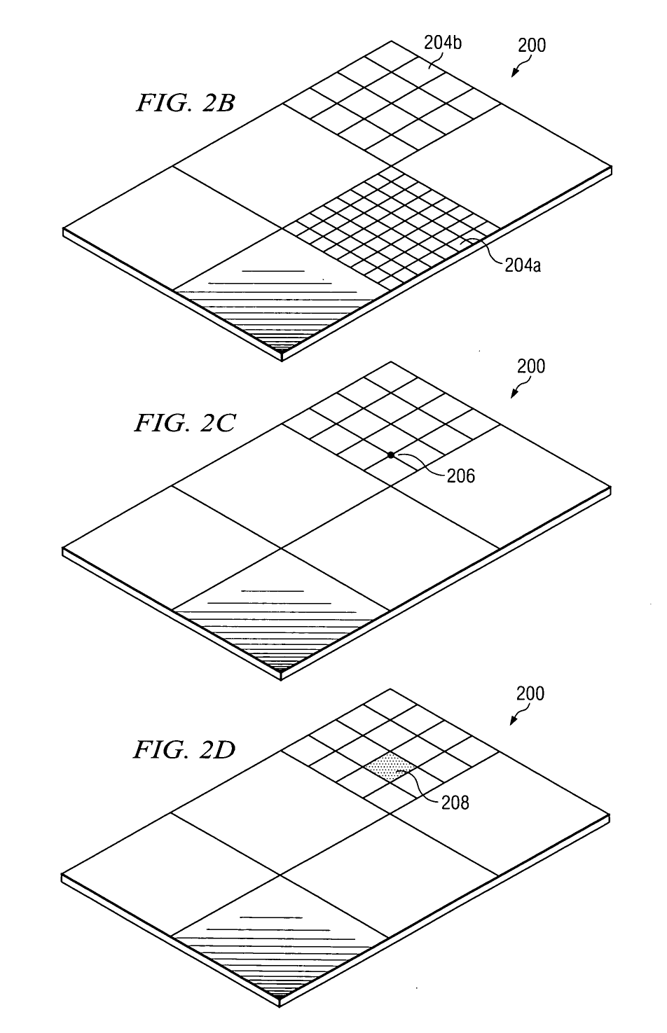

FIGS. 2A-D illustrate a grid structure 200 that may be dynamically adjusted by rendering engine 138 to generate a visual simulation of wave conditions at a specified time. It will be understood that grid structure 200 illustrates only one technique of how to generate a visual simulation of wave conditions and system 100 may use any other suitable technique for generating a visual simulation of wave conditions. Referring to FIG. 2A, a body of liquid (e.g., ocean) may initially be divided into columns and rows, such as grid structure 200, with the intersection of each defining a cell 202 of grid 200. In one embodiment, each cell 202 is uniquely identified by a column and row number. In this embodiment, the column and row number is the address of that particular cell 202. As illustrated, each cell 202 merely identifies boundaries and an address within grid 200 of geometry associated with that cell 202. FIG. 2B illustrates such geometry with meshes 204a and 204b. Each mesh 204 includes uniformly spaced, discrete points arranged in a substantially rectangular pattern as illustrated. Each point of meshes 204a and 204b may be associated with any appropriate multi-component data. For example, each point of meshes 204a and 204b may be associated with a height, horizontal position, and normal. It will be understood that each point of meshes 204a and 204b may be associated with additional information. While the horizontal dimensions of a mesh 204 are often constant through grid 200, each mesh 204 may have a different resolution, i.e., level of detail, and may range from an actual or virtual observer as illustrated in FIG. 2B. In this embodiment, the smallest indivisible element of each mesh 204 is a mesh point 206 as illustrated in FIG. 2C. FIG. 2D illustrates that four mesh points 206 may identify a mesh facet 208. Wave conditions may overlap and, as a result, transferring between wave conditions may appear seamless.

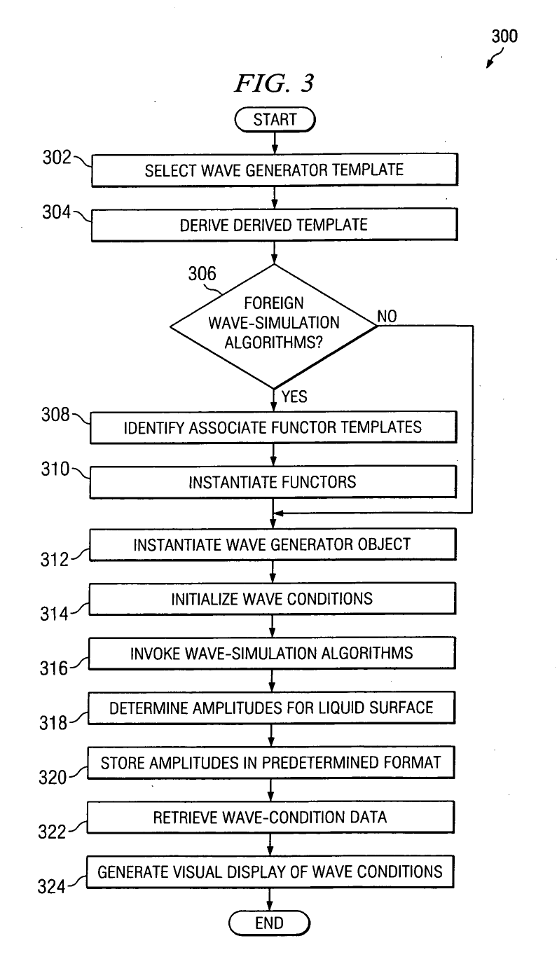

FIG. 3 is a flow diagram illustrating an example method 300 for generating a visual simulation of wave conditions. Method 300 is described with respect to system 100 of FIG. 1, but method 300 could be used by any other system or components. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

At a high level, method 300 includes generating wave generator object 128, invoking foreign wave-simulation algorithms, and generating a visual simulation of wave conditions. Method 300 begins at step 302 where computer 110 identifies wave generator template 124 based, at least in part, on a request from a user. At step 304, derived template 126 is derived from the identified wave generator template 124. In one embodiment, the user provides content for virtual and pure virtual methods of wave generator template 124 in order to derive derived template 126. If foreign wave-simulation algorithms are implemented at decisional step 306, then, at step 308, computer 110 identifies a first and second functor template 132 associated with the foreign energy spectrum and a foreign spreading function, respectively. Based, at least in part, on the first and second functor template 132, computer 110 instantiates a first and second functor 134 at step 310. Returning to decisional step 306, if foreign wave-simulation algorithms are not implemented, then execution proceeds to step 312, in which case native wave-simulation algorithms will be implemented. Next, at step 312, computer 110 instantiates wave generator object 128 based, at least in part, on derived template 126.

Turning to generating a visual display of wave conditions, wave conditions are initialized at step 314. Next, at step 316, wave generator object 128 invokes the wave-simulation algorithms (whether native or foreign) in order to update the wave conditions. In the case of foreign wave-simulation algorithms, computer 110 invokes functors 134. Once invoked, wave generator object 128 determines amplitudes for a surface of a liquid at a specified position at a specified time at step 318. At step 320, wave generator object 128 then stores amplitudes along with additional wave-condition data in a predetermined format. Rendering engine 138 retrieves the wave-condition data and generates a visual display of the wave conditions at steps 322 and 324, respectively.

Although this disclosure has been described in terms of certain embodiments and generally associated methods, alternatives and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. Software for modeling a liquid, the software embodied on computer readable media and operable to:
identify foreign wave simulation algorithms, the algorithms operable to determine wave conditions; and
dynamically generate a simulation of the wave conditions based, at least in part, on the foreign wave simulation algorithms.

2. The software of claim 1, the foreign wave simulation algorithms comprising an energy spectrum.

3. The software of claim 2, the foreign wave simulation algorithms further comprising an angular spreading function.

4. The software of claim 3, the wave conditions comprising a plurality of waves and the software further operable to determine amplitudes and phases of the plurality of waves based, at least in part, on the energy spectrum and the angular spreading function.

5. The software of claim 3, wherein the energy spectrum and the angular spreading function are implemented using functors.

6. The software of claim 3, wherein the wave conditions are dynamically generated, based at least in part, on the energy spectrum and the angular spreading function.

7. The software of claim 1, the foreign wave simulation algorithms comprising a wave model.

8. The software of claim 1, the software further operable to:
determine wave-condition data based, at least in part, on the foreign wave simulation algorithms; and
populate a data structure with at least a portion of the generated wave-condition data in a predetermined format.

9. The software of claim 1, wherein the software operable to dynamically generate a simulation of wave conditions using the foreign wave simulation algorithms comprises software operable to:
dynamically determine wave conditions using the foreign wave simulation algorithms; and
generate a visual simulation based, at least in part, on the determined wave conditions.

10. The software of claim 9, the generated visual simulation comprising a polygonal mesh.

11. A system for modeling a liquid, comprising:
memory storing wave conditions; and
one or more processors operable to:
identify foreign wave simulation algorithms, the algorithms operable to determine wave conditions; and
dynamically generate a simulation of the wave conditions based, at least in part, on the foreign wave simulation algorithms.

12. The system of claim 11, the foreign wave simulation algorithms comprising an energy spectrum.

13. The system of claim 12, the foreign wave simulation algorithms further comprising an angular spreading function.

14. The system of claim 13, the wave conditions comprising a plurality of waves and the processors further operable to determine amplitudes and phases of the plurality of waves based, at least in part, on the energy spectrum and the angular spreading function.

15. The system of claim 13, wherein the energy spectrum and the angular spreading function are implemented using functors.

16. The system of claim 13, wherein the wave conditions are dynamically generated, based at least in part, on the energy spectrum and the angular spreading function.

17. The system of claim 11, the processors further operable to:
determine wave-condition data based, at least in part, on the foreign wave simulation algorithms; and
populate a data structure with at least a portion of the generated wave-condition data in a predetermined format.

18. The system of claim 11, wherein the processor operable to dynamically generate a simulation of wave conditions using the foreign wave simulation algorithms comprises the processor operable to:
dynamically determine wave conditions using the foreign wave simulation algorithms; and
generate a visual simulation based, at least in part, on the determined wave conditions.

19. A method for modeling a liquid, the method comprising:
identifying foreign wave simulation algorithms, the algorithms operable to determine wave conditions; and
dynamically generating a simulation of the wave conditions based, at least in part, on the foreign wave simulation algorithms.

20. The method of claim 19, the foreign wave simulation algorithms comprising an energy spectrum.

21. The method of claim 20, the foreign wave simulation algorithms further comprising an angular spreading function.

22. The method of claim 21, the wave conditions comprising a plurality of waves and the method further comprising determining amplitudes and phases of the plurality of waves based, at least in part, on the energy spectrum and the angular spreading function.

23. The method of claim 21, wherein the energy spectrum and the angular spreading function are implemented using functors.

24. The method of claim 21, wherein the wave conditions are dynamically generated, based at least in part, on the energy spectrum and the angular spreading function.

25. The method of claim 19, further comprising:
determining wave-condition data based, at least in part, on the foreign wave simulation algorithms; and
populating a data structure with at least a portion of the generated wave-condition data in a predetermined format.

26. The method of claim 21, wherein dynamically generating a simulation of wave conditions using the foreign wave simulation algorithms comprises:
dynamically determining wave conditions using the foreign wave simulation algorithms; and
generating a visual simulation based, at least in part, on the determined wave conditions.

27. The method of claim 26, the generated visual simulation comprising a polygonal mesh.
